(19) United States
(12) Patent Application Publication
(10) Pub. No.: US 2025/0086934 A1
(43) Pub. Date: Mar. 13, 2025

(54) MULTICLASS CONFIDENCE AND LOCALIZATION CALIBRATION FOR OBJECT DETECTION

(71) Applicant: Mohamed bin Zayed University of Artificial Intelligence, Abu Dhabi (AE)

(72) Inventors: Bimsara PATHIRAJA, Abu Dhabi (AE); Malitha GUNAWARDHANA, Abu Dhabi (AE); Muhammad Haris KHAN, Abu Dhabi (AE)

(73) Assignee: Mohamed bin Zayed University of Artificial Intelligence, Abu Dhabi (AE)

(21) Appl. No.: 18/392,651

(22) Filed: Dec. 21, 2023

Related U.S. Application Data
(60) Provisional application No. 63/581,710, filed on Sep. 11, 2023.

(51) Int. Cl. G06V 10/764; B60W 10/18; B60W 10/20; G06T 7/11; G06V 10/776; G06V 10/80; G06V 10/82; G06V 20/58

(52) U.S. Cl. CPC G06V 10/764; B60W 10/18; B60W 10/20; G06T 7/11; G06V 10/776; G06V 10/809; G06V 10/82; G06V 20/58; B60W 2420/403; G06T 2207/20076; G06T 2207/30261

(57) ABSTRACT

A safety-critical control system and method with train-time calibration of object detection. A controller calibrates prediction by a deep neural network. The train-time calibration includes a multi-class confidence calibration, and a bounding box localization calibration. The controller outputs a calibrated image with the object bounding box, the corresponding class label, and a respective confidence score. The confidence score is a probability associated with the predicted class label. The multi-class confidence calibration is determined as a difference between a fused mean confidence and a certainty with accuracy. The fused mean confidence is between a mean logits-based class-wise confidence and class wise certainty. The controller determines the localization calibration by determining a deviation between a predicted mean bounding box overlap and a predictive certainty of the bounding box.

### CROSS-REFERENCE TO RELATED APPLICATIONS

This application claims the benefit of priority to provisional application No. 63/581,710 filed Sep. 11, 2023, the entire contents of which are incorporated herein by reference.

### STATEMENT REGARDING PRIOR DISCLOSURE BY THE INVENTORS

Aspects of this technology are described in Pathiraja, Bimsara, Malitha Gunawardhana, and Muhammad Haris Khan. “Multiclass Confidence and Localization Calibration for Object Detection.” In Proceedings of the IEEE/CVF Conference on Computer Vision and Pattern Recognition, pp. 19734-19743, 2023. The article was published online and is incorporated herein by reference in its entirety (see https://arxiv.org/abs/2306.08271).

### BACKGROUND

### Technical Field

The present disclosure relates to methods and systems for training a deep neural network (DNN) for multi-class object detection including predicting a bounding box and a class label with a confidence score for the input image. The method and system are particularly suited for safety critical features in vehicles and medical detection systems.

### Description of the Related Art

The development of self-driving car technology involves situations where aspects of human trust and acceptance are important considerations. Trust and safety are key elements for critical systems such as autonomous vehicles. That is, the users must trust that the driving agent is intelligent enough to safely drive in complex and unpredictable traffic environments. A system that is perceived as not trustworthy may not be used in the proper way or not at all, see Sara Mahmoud, Erik Billing, Henrik Svensson, Serge Thill, “Where to from here? On the future development of autonomous vehicles from a cognitive systems perspective,” Cognitive Systems Research, Volume 76, 2022, Pages 63-77. The field of autonomous vehicles needs to address the user perception of a trustworthy system.

One of the challenges for perception is the need for training on large amounts of data to learn how to handle the input data, which has significant consequences for self-driving cars. The nature of the sensory data to be collected is more than just dispersed images of objects but a composition of real world scenes and scenarios. In addition, the sensory data will include objects that a self-driving car will encounter.

There are various safety-critical applications of computer vision systems in which wrong predictions can lead to disastrous consequences. Safety-critical applications include healthcare diagnosis and legal research tools, as well as self-driving cars. Such safety-critical applications as car and pedestrian detection, road and lane detection, traffic light detection, and road scenes require precise detection. In self-driving cars, if the perception component wrongly detects a stop sign as a speed limit sign with high confidence, it can potentially lead to disastrous outcomes.

Deep neural networks (DNNs) are the backbone of many top-performing systems due to their high predictive performance across several challenging domains, including computer vision and natural language processing. See Kaiming He, Georgia Gkioxari, Piotr Dollar, and Ross Girshick. Mask r-cnn. In The IEEE International Conference on Computer Vision (ICCV), October 2017; Kaiming He, Xiangyu Zhang, Shaoqing Ren, and Jian Sun. Deep residual learning for image recognition. In Proceedings of the IEEE conference on computer vision and pattern recognition, pages 770-778, 2016; Olaf Ronneberger, Philipp Fischer, and Thomas Brox. Unet: Convolutional networks for biomedical image segmentation. In International Conference on Medical image computing and computer-assisted intervention, pages 234-241. Springer, 2015; Zhi Tian, Chunhua Shen, Hao Chen, and Tong He. Fcos: Fully convolutional one-stage object detection. In Proceedings of the IEEE international conference on computer vision, pages 9627-9636, 2019; Xizhou Zhu, Weijie Su, Lewei Lu, Bin Li, Xiaogang Wang, and Jifeng Dai. Deformable {detr}: Deformable transformers for end-to-end object detection. In International Conference on Learning Representations, 2021; Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. Language models are few-shot learners. Advances in neural information processing systems, 33:1877-1901, 2020; and Jacob Devlin, Ming-Wei Chang, Kenton Lee, and Kristina Toutanova. Bert: Pre-training of deep bidirectional transformers for language understanding. arXiv preprint arXiv: 1810.04805, 2018.

However, some recent works report that DNNs are susceptible to making overconfident predictions, which leaves them miscalibrated. See Chuan Guo, Geoff Pleiss, Yu Sun, and Kilian Q Weinberger. On calibration of modern neural networks. In International Conference on Machine Learning, pages 1321-1330. PMLR, 2017; Marton Havasi, Rodolphe Jenatton, Stanislav Fort, Jeremiah Zhe Liu, Jasper Snoek, Balaji Lakshminarayanan, Andrew M Dai, and Dustin Tran. Training independent subnetworks for robust prediction. arXiv preprint arXiv: 2010.06610, 2020; Yaniv Ovadia, Emily Fertig, Jie Ren, Zachary Nado, David Sculley, Sebastian Nowozin, Joshua Dillon, Balaji Lakshminarayanan, and Jasper Snoek. Can you trust your model's uncertainty? evaluating predictive uncertainty under dataset shift. Advances in neural information processing systems, 32, 2019; and Florian Wenzel, Jasper Snoek, Dustin Tran, and Rodolphe Jenatton. Hyperparameter ensembles for robustness and uncertainty quantification. Advances in Neural Information Processing Systems, 33:6514-6527, 2020, each incorporated herein by reference in their entirety. This not only spurs a mistrust in their predictions, but more importantly, could lead to disastrous consequences in several safety-critical applications, such as healthcare diagnosis, self-driving cars, and legal research tools. See Michael W Dusenberry, Dustin Tran, Edward Choi, Jonas Kemp, Jeremy Nixon, Ghassen Jerfel, Katherine Heller, and Andrew M Dai. Analyzing the role of model uncertainty for electronic health records. In Proceedings of the ACM Conference on Health. Inference, and Learning, pages 204-213, 2020; Monika Sharma, Oindrila Saha, Anand Sriraman, Ramya Hebbalaguppe, Lovekesh Vig, and Shirish Karande. Crowd-sourcing for chromosome segmentation and deep classification. In Proceedings of the IEEE conference on computer vision and pattern recognition workshops, pages 34-41, 2017; Sorin Grigorescu, Bogdan Trasnea, Tiberiu Cocias, and Gigel Macesanu. A survey of deep learning techniques for autonomous driving. Journal of Field Robotics, 37(3):362-386, 2020; and Ronald Yu and Gabriele Spina Alì. What's inside the black box? ai challenges for lawyers and researchers. Legal Information Management, 19(1):2-13, 2019.

Several strategies have been proposed for improving model calibration. A simple calibration technique is a post-processing step that re-scales the outputs of a trained model using parameters which are learnt on a hold-out portion of the training set. Despite being easy to implement, these post-processing approaches are restrictive. They assume the availability of a hold-out set, which is not always possible in many real-world settings. Another route to reducing calibration error is train-time calibration techniques, which intervene at the training time by involving all model parameters. Typically train-time calibration methods feature an auxiliary loss term that is added to the application-specific loss function to regularize predictions. See Ramya Hebbalaguppe, Jatin Prakash, Neelabh Madan, and Chetan Arora. A stitch in time saves nine: A train-time regularizing loss for improved neural network calibration. In Proceedings of the IEEE/CVF Conference on Computer Vision and Pattern Recognition (CVPR), pages 16081-16090, June 2022; Aviral Kumar, Sunita Sarawagi, and Ujjwal Jain. Trainable calibration measures for neural networks from kernel mean embeddings. In International Conference on Machine Learning, pages 2805-2814. PMLR, 2018; Bingyuan Liu, Ismail Ben Ayed, Adrian Galdran, and Jose Dolz. The devil is in the margin: Margin-based label smoothing for network calibration. In Proceedings of the IEEE/CVF Conference on Computer Vision and Pattern Recognition (CVPR), pages 80-88, June 2022; Jishnu Mukhoti, Viveka Kulharia, Amartya Sanyal, Stuart Golodetz, Philip Torr, and Puneet Dokania. Calibrating deep neural networks using focal loss. Advances in Neural Information Processing Systems, 33:15288-15299, 2020.

Post-processing calibration methods re-scale the outputs of a trained model using some parameters that are learned on the hold-out portion of the training set. Temperature scaling (TS), which is an adaptation of Platt scaling, is a prominent example of post-processing calibration. See John Platt et al. Probabilistic outputs for support vector machines and comparisons to regularized likelihood methods. Advances in large margin classifiers, 10(3):61-74, 1999. It divides the logits (pre-softmax activations) from a trained network with a fixed temperature parameter (T>0) that is learned using a holdout validation set. A limitation of TS is that it decreases the confidence of the whole (confidence) vector, including the confidence of the correct class. Beyond using a single temperature parameter (T), some works uses a matrix (M) to transform the logits. The matrix (M) is also learnt using a hold-out validation set. Dirichlet calibration (DC) employed Dirichlet distributions to generalize the Beta-calibration method, originally proposed for binary classification, to a multi-class setting. See Meelis Kull, Telmo Silva Filho, and Peter Flach. Beta calibration: a well-founded and easily implemented improvement on logistic calibration for binary classifiers. In Artificial Intelligence and Statistics, pages 623-631. PMLR, 2017. DC is realized as an extra layer in a neural network whom input is log-transformed class probabilities. A differentiable approximation of expected calibration error (ECE) and utilizes it in a meta-learning framework to obtain well-calibrated models has been proposed. See Ondrej Bohdal, Yongxin Yang, and Timothy Hospedales. Meta-calibration: Meta-learning of model calibration using differentiable expected calibration error. arXiv preprint arXiv: 2106.09613, 2021. A class-distribution-aware calibration using temperature scaling (TS) and label smoothing (LS) for long-tailed visual recognition has been achieved. See Mobarakol Islam, Lalithkumar Seenivasan, Hongliang Ren, and Ben Glocker. Class-distribution-aware calibration for long-tailed visual recognition. arXiv preprint ar Xiv: 2109.05263, 2021; and Christian Szegedy, Vincent Vanhoucke, Sergey Ioffe, Jon Shlens, and ZbigniewWojna. Rethinking the inception architecture for computer vision. In Proceedings of the IEEE conference on computer vision and pattern recognition, pages 2818-2826, 2016. The majority of the aforementioned work address in-domain calibration. Recently, gradual perturbation of the hold-out validation set for simulating out-of-domain prior to learning the temperature parameter (T) was proposed. See Christian Tomani, Sebastian Gruber, Muhammed Ebrar Erdem, Daniel Cremers, and Florian Buettner. Post-hoc uncertainty calibration for domain drift scenarios. In Proceedings of the IEEE/CVF Conference on Computer Vision and Pattern Recognition, pages 10124-10132, 2021. Despite being easy-to-implement and effective, TS methods require a hold-out validation set, which is not readily available in many realistic scenarios.

Train-time calibration techniques include Brier score, which is considered one of the earliest attempts for calibrating binary probabilistic forecast. See Glenn W Brier et al. Verification of forecasts expressed in terms of probability. Monthly weather review, 78(1):1-3, 1950. Some works report that models trained with negative loglikelihood (NLL) are prone to making overconfident predictions. A dominant class in train-time methods typically propose an auxiliary loss term that is used in conjunction with NLL. For instance, the Shanon entropy was utilized to penalize overconfident predictions. See Gabriel Pereyra, George Tucker, Jan Chorowski, Łukasz Kaiser, and Geoffrey Hinton. Regularizing neural networks by penalizing confident output distributions. arXiv preprint arXiv: 1701.06548, 2017. Similarly, label smoothing was shown to also improve calibration. See Rafael Müller, Simon Kornblith, and Geoffrey E Hinton. When does label smoothing help? Advances in neural information processing systems, 32, 2019; and Szegedy et al. Recently, a margin into the label smoothing technique was introduced to obtain well-calibrated models. While re-visiting focal loss (FL), it was. demonstrated that it is capable of implicitly calibrating DNNs. See Tsung-Yi Lin, Priyal Goyal, Ross Girshick, Kaiming He, and Piotr Dollár. Focal loss for dense object detection. IEEE transactions on pattern analysis and machine intelligence, 2018. The difference between confidence and accuracy (DCA) as an auxiliary loss term with the Cross-Entropy loss to achieve model calibration has been used. See Gongbo Liang, Yu Zhang, Xiaoqin Wang, and Nathan Jacobs. Improved trainable calibration method for neural networks on medical imaging classification. In British Machine Vision Conference (BMVC), 2020. Likewise, Kumar et al. developed MMCE loss for calibrating DNNs, which is formulated using a reproducible kernel in Hilbert space. See Arthur Gretton. Introduction to rkhs, and some simple kernel algorithms. Adv. Top. Mach. Learn. Lecture Conducted from University College London, 16:5-3, 2013. Most of these methods only calibrate the confidence of the predicted label ignoring the confidences of non-predicted classes. An auxiliary loss term for calibrating the whole confidence vector has been proposed.

Many probabilistic approaches stem from Bayesian formalism, which assumes a prior distribution over the neural network (NN) parameters, and training data is leveraged to obtain the posterior distribution over the NN parameters. See José M Bernardo and Adrian F M Smith. Bayesian theory, volume 405. John Wiley & Sons, 2009. This posterior is then used to estimate the predictive uncertainty. The exact Bayesian inference is computationally intractable. Consequently, approximate inference methods have been developed, including variational inference, and stochastic expectation propagation. See Charles Blundell, Julien Cornebise, Koray Kavukcuoglu, and DaanWierstra. Weight uncertainty in neural network. In International conference on machine learning, pages 1613-1622. PMLR, 2015; Christos Louizos and Max Welling. Structured and efficient variational deep learning with matrix gaussian posteriors. In International conference on machine learning, pages 1708-1716. PMLR, 2016; and José Miguel Hernández-Lobato and Ryan Adams. Probabilistic backpropagation for scalable learning of Bayesian neural networks. In International conference on machine learning, pages 1861-1869. PMLR, 2015. A non-probabilistic approach is ensemble learning that can be used to quantify uncertainty. It uses the empirical variance of the network predictions. Ensembles can be created with the differences in model hyperparameters, random initialization of weights and random shuffling of training data, dataset shift, and Monte Carlo (MC) dropout. See Wenzel et al.; Balaji Lakshminarayanan, Alexander Pritzel, and Charles Blundell. Simple and scalable predictive uncertainty estimation using deep ensembles. Advances in neural information processing systems, 30, 2017; Ovadia et al; Yarin Gal and Zoubin Ghahramani. Dropout as a Bayesian approximation: Representing model uncertainty in deep learning. In international conference on machine learning, pages 1050-1059. PMLR, 2016; and Zhilu Zhang, Adrian V Dalca, and Mert R Sabuncu. Confidence calibration for convolutional neural networks using structured dropout. arXiv preprint arXiv: 1906.09551, 2019.

Almost all prior work for addressing calibration is targeted at the classification task, and no noticeable study has been published that strives to improve the calibration of object detection methods, especially for out-of-domain predictions.

Visual object detection methods account for a major and critical part of many vision-based decision-making systems. Moreover, most of the current calibration techniques only aim at reducing calibration error for in-domain predictions. However, in many realistic settings, it is likely that, after model deployment, the incoming data distribution could continuously change from the training data distribution. In essence, the model should be well-calibrated for both in-domain and out-of-domain predictions.

An object is a train-time calibration method aimed at jointly calibrating multiclass confidence and bounding box localization. An object is a solution to the problem of calibrating object detectors which are inherently miscalibrated for both in-domain and out-domain predictions.

There is a need for calibration of deep learning-based object detection methods. Object detection methods have a problem that they are intrinsically mis-calibrated. Also, besides displaying noticeable calibration errors for in-domain predictions, they are also poorly calibrated for out-of-domain predictions. Further, conventional calibration techniques for classification are sub-optimal for object detection.

Accordingly it is one object of the present disclosure to provide a method and system of training a deep neural network (DNN) for multi-class object detection using an object detection system.

### SUMMARY

An aspect is a method of training a deep neural network (DNN) for multi-class object detection using an object detection system, the object detection system including a camera and a controller having the DNN, the method can include capturing an image by the camera; receiving, by the controller, the image; predicting, using the DNN, at least one bounding box and a class label with a confidence score for the image; calibrating the DNN by a multi-class confidence calibration, and a bounding box localization calibration; and outputting, by the controller, a calibrated image with the object bounding box, the corresponding class label, and a respective confidence score, wherein the confidence score is a probability associated with the predicted class label.

A further aspect is a vehicle safety-critical control system that can include a camera capturing an image; a controller receiving the image and configured with a deep neural network; the DNN configured to predict at least one bounding box and a class label with a confidence score for the image; the controller further configured to calibrate the prediction by the DNN by a multi-class confidence calibration, and a bounding box localization calibration; and the controller further configured to output a calibrated image with the object bounding box, the corresponding class label, and a respective confidence score, wherein the confidence score is a probability associated with the predicted class label.

A non-transitory computer-readable storage medium including computer executable instructions, wherein the instructions, when executed by a computer, cause the computer to perform a method that can include receiving an image; predicting, using a deep neural network (DNN), at least one bounding box and a class label with a confidence score for the image; calibrating the DNN by a multi-class confidence calibration, and a bounding box localization calibration; and outputting a calibrated image with the object bounding box, the corresponding class label, and a respective confidence score, wherein the confidence score is a probability associated with the predicted class label.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A-1C illustrate DNN-based object detectors are inherently miscalibrated for both in-domain and out-of-domain predictions;

FIG. 2 is a diagram of levels of automation for vehicles;

FIG. 3 is a block diagram of a control system for multi-sensor equipped vehicle;

FIG. 4 is a system diagram of a control system for an autonomous vehicle;

FIG. 5 is a block diagram of architecture for FCOS network as a baseline architecture;

FIGS. 6A-6D illustrate confidence histograms for baseline and our method;

FIGS. 7A-7D illustrate reliability diagrams for baseline and our method;

FIG. 8 illustrates a histogram of confidence values for incorrect predictions by baseline (FCOS) and our method in COCO dataset;

FIG. 9 illustrates the D-ECE convergence for baseline, the classification and localization components of our MCCL, and MCCL;

FIGS. 10A-10D illustrate calibration precision, confidence, and ECE with IOU @0.5 of (a) baseline (FCOS) relative to center-x (cₓ), (b) our method relative to center-x (cₓ) (c) baseline (FCOS) relative to center-y (c_{y}), and (d) our method relative to center-y (c_{y}); and

FIGS. 11A-11D illustrate calibration heatmap of (a,b) baseline (FCOS) and our method over center-x (cₓ) and center-y (c_{y}) with IOU @0.5, (c,d) baseline (FCOS) and our method over width (w) and height (h) with IOU @0.5.

### DETAILED DESCRIPTION

The presently disclosed train-time calibration method for object detection can be evaluated using calibration error (ECE %) of DNN-based detectors in both in-domain and out-domain scenarios. In the present disclosure, a location-dependent calibration, termed as detection ECE (D-ECE) is preferentially used.

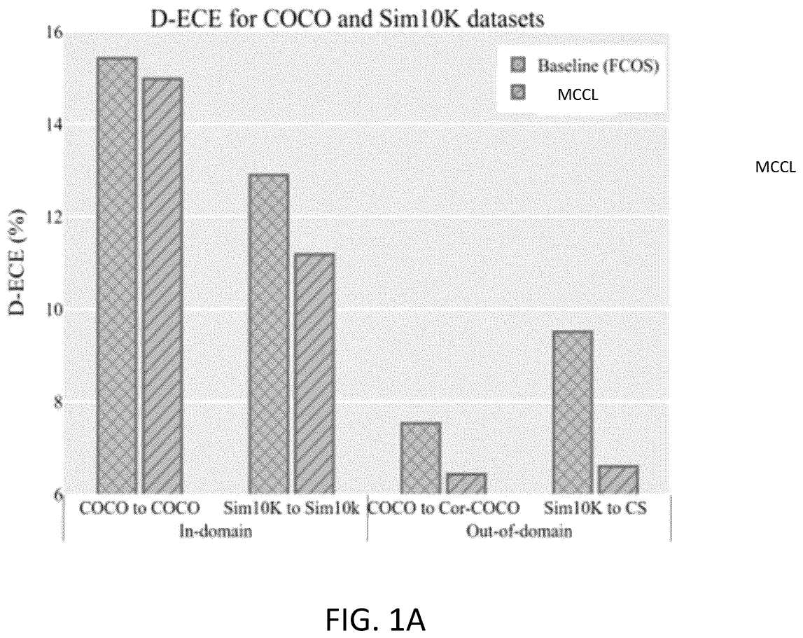

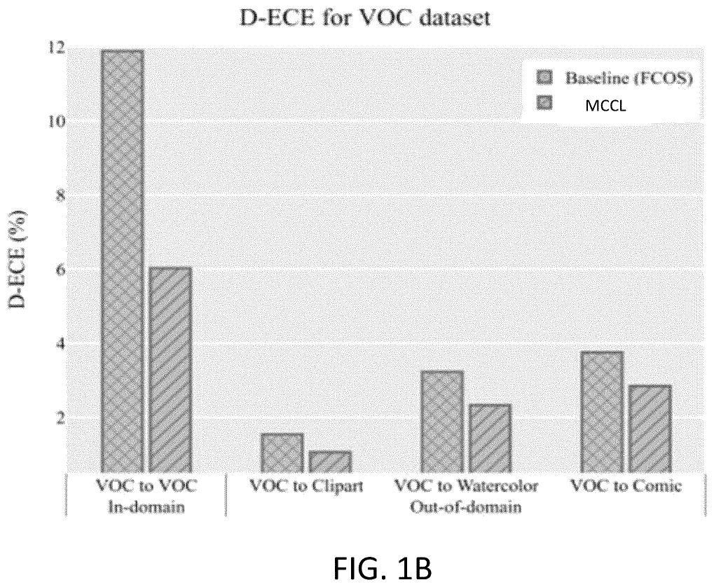

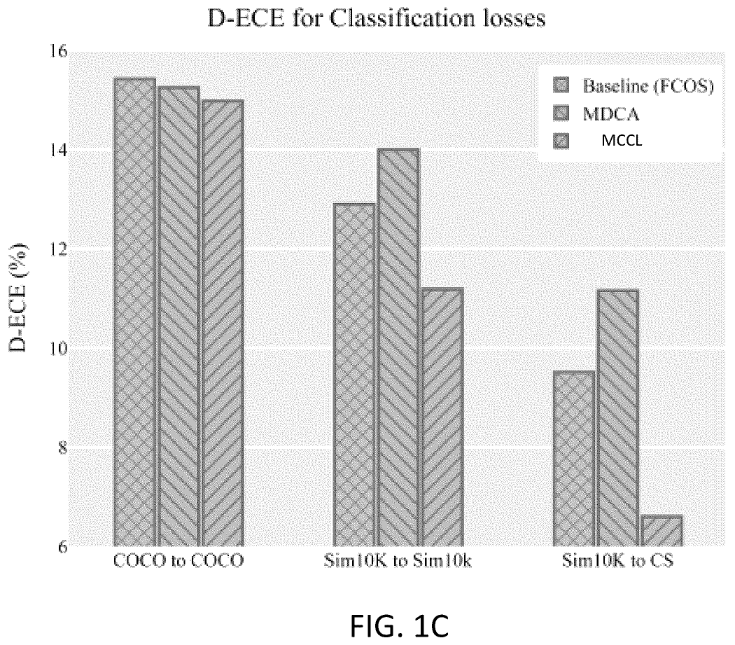

FIGS. 1A, 1B, 1C are charts that highlight the performance of the present approach over other DNN-based object detectors. As evidenced by the charts in FIGS. 1A, 1B, 1C, DNN-based object detectors are inherently miscalibrated for both in-domain and out-of-domain predictions. Also, calibration methods for image classification are sub-optimal for object detection. The train-time calibration method for object detection of the present disclosure is capable of reducing the calibration error (D-ECE %) of DNN-based detectors in both in-domain and out-domain scenarios.

Aspects of the present disclosure include a train-time calibration approach that jointly calibrates predictive multiclass confidence and bounding box localization.

In an embodiment, a train-time calibration method for object detection includes an auxiliary loss term, which jointly calibrates multiclass confidences and bounding box localization. The embodiment leverages predictive uncertainty in multiclass confidences and bounding box localization. The auxiliary loss term is differentiable, operates on minibatches, and can be utilized with other task-specific loss functions.

Extensive experiments test the auxiliary loss term on challenging datasets, featuring several in-domain and out-of-domain scenarios. The train-time calibration method consistently reduces the calibration error across DNN-based object detection paradigms, including FCOS and Deformable DETR, both in in-domain and out-of-domain predictions.

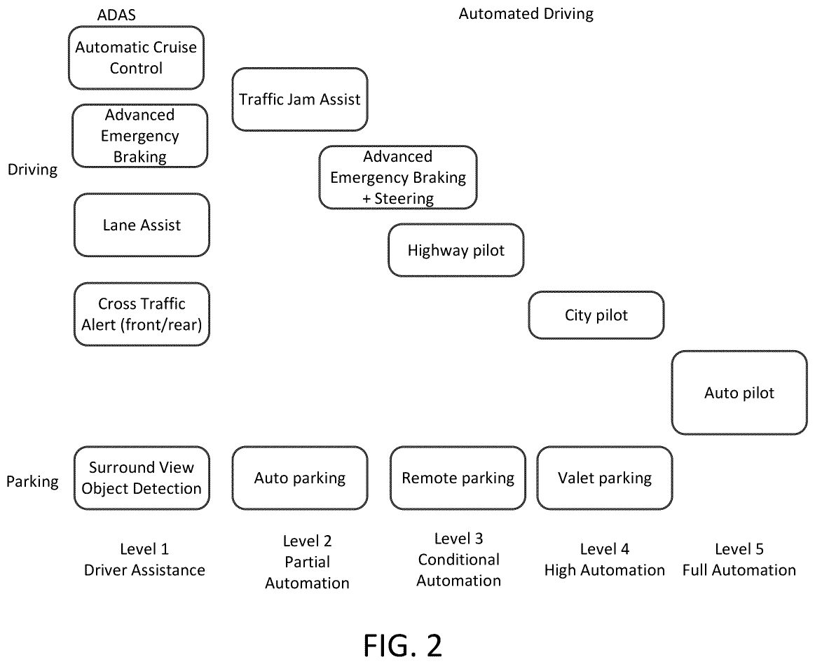

The development of self-driving cars is one of the most challenging research areas in robotics, made more difficult by the fact that mistakes may cost lives. Automation in self-driving cars is often defined by the Society of Automotive Engineers' (SAE) levels of autonomy ranging from zero to five. FIG. 2 is a diagram of levels of automation for vehicles. Level 0 is momentary drive assistance, where a driver is fully responsible for driving the vehicle while system provides momentary driving assistance, like warnings and alerts, or emergency safety interventions. Level 1 is driver assistance, where the driver is fully responsible for driving the vehicle while system provides continuous assistance with either acceleration/braking or steering. Level 1 can include automatic cruise control, advanced emergency braking, lane assist, and cross traffic alert (front/read), as well as surround view object detection. Level 2 is additional driver assistance (partial automation), where the driver is fully responsible for driving the vehicle while system provides continuous assistance with both acceleration/braking and steering. Level 2 can include automatic parking. Level 3 is conditional automation, where the system handles all aspects of driving while driver remains available to take over driving if system can no longer operate. Level 4 is high automation, where when engaged, the system is fully responsible for driving tasks within limited service areas. A human driver is not needed to operate the vehicle. Level 5 is full automation (auto pilot), where when engaged, the system is fully responsible for driving tasks under all conditions and on all roadways. A human driver is not needed to operate the vehicle.

Situations in which a car may operate autonomously under certain conditions start at level three. At this level, the human driver remains ready to take over when the system fails to proceed. Despite being an active topic of industrial and academic research, there are presently no widely accepted solutions that reach Level 5.

A perception-decision-making architecture for a self-driving car may be broken down into sub-systems. A perception system links an agent to the environment through different types of sensor sub-systems such as cameras, LIDAR, radar, GPS and odometers.

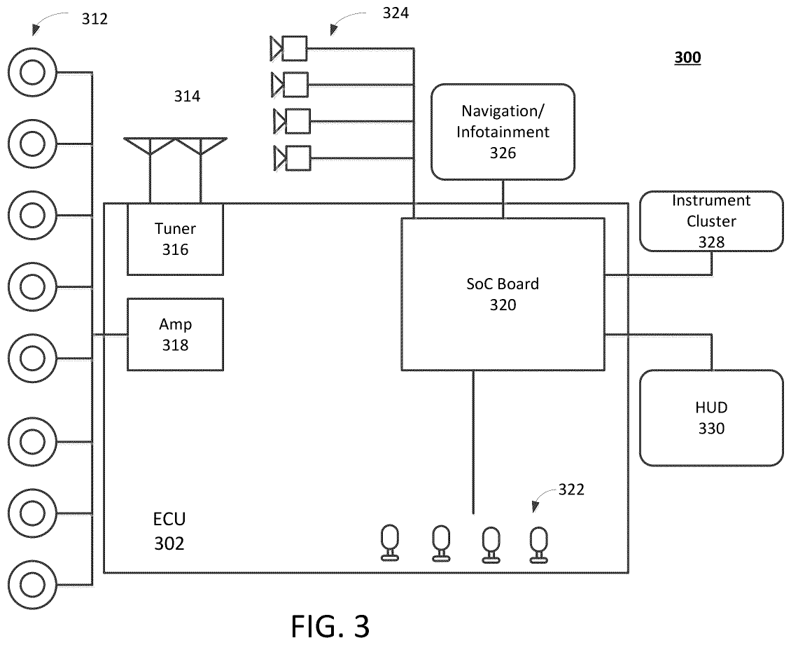

FIG. 3 is a block diagram of a control system for multi-sensor equipped vehicle. The control system 300 includes sensors, such as a number of radar sensors 312, antennas 314, video cameras 324, microphones 322. An electronic control unit (ECU) 302 can include a tuner 316 and Amp 318, and a system on chip (SoC) 320. The SoC 302 can include various processing circuitry within a single semiconductor chip, including one or more central processing units (CPUs), one or more graphics processing units (GPUs), and a multicore machine learning processor. The SoC 320 can be connected to a infotainment cluster 326, instrument cluster 328, and head up display (HUD) 330.

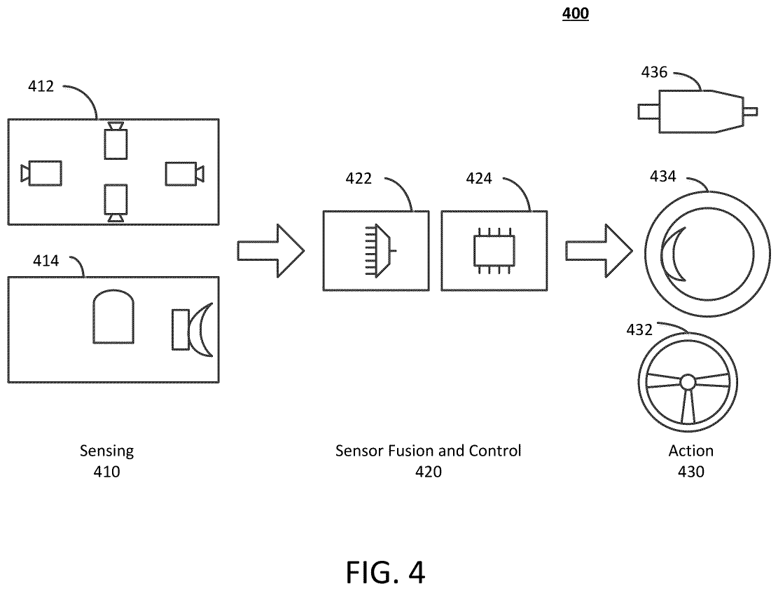

FIG. 4 is a system diagram of a control system for an autonomous vehicle. An autonomous vehicle can include a sensing component 410, various actuators 430 controlled through sensor fusion and control 420. The sensing component 410 for a vehicle can include, but is not limited to, one or more cameras 412 mounted to the vehicle to provide an external view of the surrounding environment. Other sensors 414 may be mounted to the vehicle can include radar and sonar sensors, to name a few. A sensor fusion component 422 can collect input from sensors and synchronize signals so that they correspond in time. A controller 424 performs control operations based on the sensor inputs and can output actuation signals to actuators 430. Actuators 430 can include motion actuators for steering system 432, braking system 434, and transmission 436.

The controller 424 may send operation signals to the steering system 432, braking system 434, and transmission system 436, either independently or in combination. For example, in some vehicles, brakes and transmission may be operated in conjunction to control speed of the vehicle, such as slowing or accelerating the vehicle. Some vehicles may be equipped with driver assist features such as automatic parking that may involve control of steering and braking. In all control conditions, the controller 424 may monitor the environment to check for presence of objects and/or persons, and control motion of the vehicle accordingly, for purposes of safety and avoid vehicle damage.

The controller 424 may be any processing device configured for external connection to various sensors and actuators. In addition, the controller 424 may be a function of the SoC 320 of FIG. 3. The control functions, as well as machine learning disclosed herein may be implemented using computer software stored in computer readable storage medium, that is executed by processing circuitry, including SoC 320. The storage medium may include any non-volatile memory device, including EEPROM, ROM, Flash memory, to name a few.

Many challenges may occur in the perception system. Detecting and recognizing traffic lights and road signs is one challenge for self-driving cars. Weather conditions, for example, may cause difficulties in detecting traffic lights and road signs or the signal changes in lights and road signs in rain, snow or fog.

### Method

### 1. Defining and Measuring Calibration

A perfectly calibrated model for image classification outputs class confidences that match with the predictive accuracy. If the accuracy is less than the confidence, then the model is overconfident and if the accuracy is higher than the confidence, then the model is underconfident. Let [symbol] = [symbol] (xᵢ, y*ₜ) [symbol] denote a dataset consisting of N examples drawn from a joint distribution [symbol] ( [symbol] , [symbol] ), where [symbol] is an input space and [symbol] is the label space. For each sample xᵢ∈ [symbol] , y*ᵢ∈ [symbol] ={1, 2, . . . K} is the corresponding ground truth class label. Let s∈ [symbol] be the vector containing the predicted confidences of all K classes, and sᵢ[y] be the confidence predicted for a class y on a given input example xᵢ. The model is said to be perfectly calibrated when, for each sample (x, y)∈ [symbol] :

$$ℙ ( y = {y}^{⋆} \vert s [ y ] = s ) = s \qquad ( 1 )$$

where [symbol] (y=y*|s[y]=s) is the accuracy for each confidence scores in s.

Contrary to image classification, in object detection, the dataset contains the ground-truth annotations for each object in an image, specifically the object localization information and the associated object categories. Let b*∈ [symbol] =[0,1]⁴ be the bounding box annotation of the object and y* be the corresponding class label. The prediction from an object detection model consists of a class label ŷ, with a confidence score ŝ and a bounding box \hat{b}. Unlike image classification, for object detection, precision is used instead of accuracy for calibration. Therefore, an object detector is perfectly calibrated when:

$$( m = 1 \vert \hat{s} = s , \hat{y} = y , \hat{b} = b ) = s \qquad ( 2 )$$

$$∀ s ∈ [ 0 , 1 ] , y ∈ 𝓎 , b ∈ {[ 0 , 1 ]}^{4}$$

where m=1 denotes a correctly classified prediction i.e. whose ŷ matches with the y* and the Intersection-over-Union (IoU) between \hat{b} and b* is greater than a certain threshold γ. See Fabian Küppers, Jan Kronenberger, Amirhossein Shantia, and Anselm Haselhoff. Multivariate confidence calibration for object detection. In The IEEE/CVF Conference on Computer Vision and Pattern Recognition (CVPR) Workshops, June 2020, incorporated herein by reference in its entirety. Thus, [symbol] (m=1) amounts to approximating [symbol] (ŷ=y*, \hat{b}=b*) with a certain IoU threshold γ.

It is useful to measure miscalibration for image classification and object detection. For image classification, the expected calibration error (ECE) is used to measure the miscalibration of a model. The ECE measures the expected deviation of the predictive accuracy from the estimated confidence:

$${\overline{s}}_{} [ \vert ( \hat{y} = y \vert \hat{s} = s ) - s \vert ] \qquad ( 3 )$$

See Guo et al.; Küppers et al.; and Mahdi Pakdaman Naeini, Gregory Cooper, and Milos Hauskrecht. Obtaining well calibrated probabilities using bayesian binning. In Twenty-Ninth AAAI Conference on Artificial Intelligence, 2015, each incorporated herein by reference in their entirety.

As ŝ is a continuous random variable, the ECE is approximated by binning the confidence space of ŝ into N equally spaced bins. Therefore, ECE is approximated by:

$$ECE = {\sum }_{n = 1}^{N} \frac{\vert I ( n ) \vert}{\vert 𝒟 \vert} \cdot \vert acc ( n ) - conf ( n ) \vert \qquad ( 4 )$$

where |I(n)| is the number of examples in the n^{th} bin, and | [symbol] | is the total number of examples. acc(n) and conf(n) denote the average accuracy and average confidence in the n^{th} bin, respectively. Although the ECE measure can be used for measuring miscalibration of object detectors, it fails to reflect the calibration improvement when additional box coordinates are used for calibration since the ECE considers confidence of each example independent of the box properties to apply binning and to calculate an average precision. In one embodiment, a location-dependent calibration is used, termed as detection ECE (D-ECE). It is defined as the expected deviation of the observed precision with respect to the given box properties.

$${s b}_{} [ \vert ( m = 1 \vert \hat{s} = s , \hat{y} = y , \hat{b} = b ) - s \vert ] \qquad ( 5 )$$

Similar to ECE, the multidimensional D-ECE is calculated by partitioning both the confidence and box property spaces in each dimension k into Nₖ equally spaced bins.

Thus, D-ECE is given by:

$$D - {ECE}_{k} = {\sum }_{n = 1}^{{N}_{total}} \frac{\vert I ( n ) \vert}{\vert \vert} \cdot \vert prec ( n ) - conf ( n ) \vert \qquad ( 6 )$$

where Nₜₒₜₐₗ is the total number of bins. prec(n) and conf(n) denote the average precision and confidence in each bin, respectively.

### 2. Train-Time Calibration: MCCL

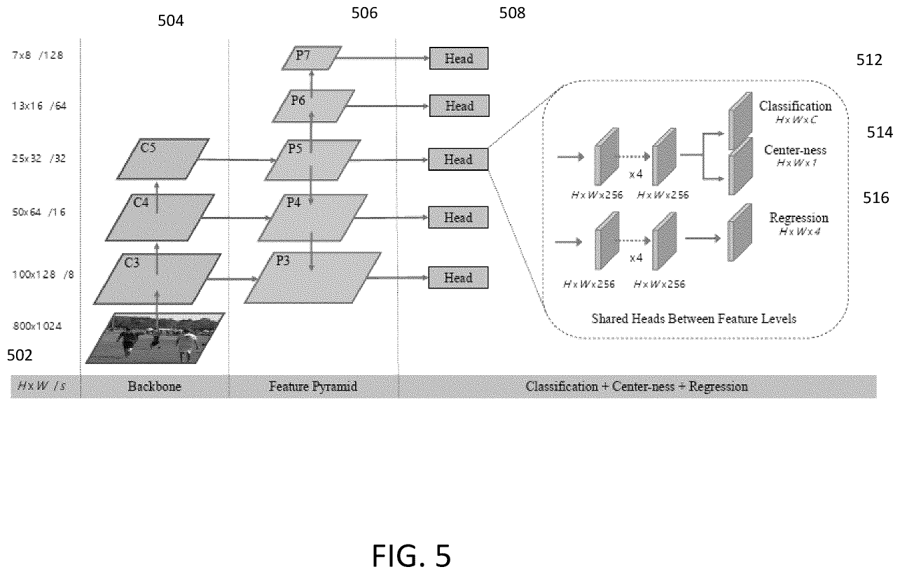

A baseline architecture for the MCCL is a CNN-based object detector, namely fully convolutional one-stage object detector (FCOS). FIG. 5 is a diagram illustrating the network architecture of FCOS, where C3, C4, and C5 denote backbone feature maps 504 and P3 to P7 506 are the feature levels used for the final prediction. H×W is the height and width of feature maps. ‘/s’ (s=8, 16, . . . , 128) is the downsampling ratio of the feature maps at the level to the input image 502. As an example, all the numbers are computed with an 800×1024 input image. Each feature level P3 to P7 506 outputs to shared heads 508.

Four convolutional layers are added after the feature maps 504 of the backbone networks respectively for classification 512 and regression branches 516. L_{cls} is focal loss and L_{reg} is the IOU loss. Nₚₒₛ denotes the number of positive samples and λ being 1 is the balance weight for L_{reg}. The summation is calculated over all locations on the feature maps Fᵢ. 1_{{c*}_{ᵢ}^{>0}} is the indicator function, being 1 if c*ᵢ>0 and 0 otherwise.

A single layer branch 514 is added in parallel with the classification branch to predict the “center-ness” of a location 2. The center-ness depicts the normalized distance from the location to the center of the object that the location is responsible for.

The inference of FCOS is includes, given input images, forward it through the network and obtain the classification scores p_{x;y} and the regression prediction t_{x;y} for each location on the feature maps Fᵢ. Choose the location with p_{x;y}>0:05 as positive samples and invert Eq. (1) to obtain the predicted bounding boxes.

A train-time calibration method is disclosed that at its core is an enhanced auxiliary loss function. This enhanced auxiliary loss formulation aims at jointly calibrating the multiclass confidence and bounding box localization during training. It is based on the fact that, the conventional object detectors (based on DNNs) predict a confidence vector along with the bounding box parameters.

Multiclass classification is a problem of classifying instances into one of three or more classes. Multiclass confidence is a confidence that each class confidence matches a predictive accuracy.

Bounding box localization is a location of the bounding box in an image.

The two key quantities to the loss function are (1) the predictive certainty in class logits and the bounding box localization and, (2) the class-wise confidence after computing class-wise logits mean (termed mean logits based class-wise confidence hereafter) and mean bounding box localization. The predictive certainty in class-wise logits is used in-tandem with the mean logits based class-wise confidence to calibrate the multi-class confidence scores. While the predictive certainty in the bounding box prediction is used to calibrate the bounding box localization. Instead of inputting the class-wise logits and predicted bounding box parameters to the classification loss and regression loss in task-specific detection losses, the class-wise mean logits and mean bounding box parameters are input, respectively. The mean logits based class-wise confidence, mean bounding box parameters, and the certainty in both class logits and bounding box localization is computed.

In particular, the Quantifying means and certainties are quantified. For the n^{th} positive location, quantify the mean logits based class-wise confidence s̅ₙ∈ [symbol] and class-wise certainty in logits cₙ∈ [symbol] as well as the mean bounding box parameters b̅ₙ∈[0,1]^{J} and certainty in bounding box localization gₙ. Where J is the number of bounding box parameters.

A Monte Carlo (MC) dropout method is used to quantify predictive uncertainty both in class confidences and the bounding localization. See Gal et al. The MC dropout method allows creating a distribution over both outputs from a typical DNN-based object detector. However, the naive implementation of the MC dropout method can incur high computational cost for large datasets and network architectures during model training. Subsequently, the MCCL method uses an efficient implementation of the MC dropout method that greatly reduces this computational overhead.

Given an input sample image, the MCCL method performs N stochastic forward passes by applying the Monte-Carlo (MC) dropout method. The MC dropout method generates a distribution over class logits and bounding box localization. Assuming one-stage object detector (e.g., Tian et al.), a dropout layer is inserted before the classification layer 512 and the regression layer 516. Let zₙ∈ [symbol] and rₙ∈ [symbol] encode the distributions over class-wise logit scores and bounding box parameters, respectively, corresponding to the n^{th} positive location obtained after performing N, MC forward passes.

The mean logits based class-wise confidence s̅ₙ∈ [symbol] is obtained by first taking the mean along the first dimension of zₙ to get class-wise mean logits and then applying the softmax. To obtain class-wise certainty cₙ, first estimate the uncertainty dₙ∈ [symbol] by computing the variance along the first dimension of zₙ. Then, apply tanh over dₙ and subtract it from 1 as: cₙ=1−tanh(dₙ), where tanh is used to scale the uncertainty dₙ∈[0, inf) between 0 and 1.

Similarly, the mean bounding box parameters b̅ₙ and the certainty gₙ in the bounding box parameters are estimated for the n^{th} positive location. Let {σₙ²}ⱼ₌₁^{J} and {μₙ}ⱼ₌₁^{J} be the vectors (J is the number of bbox parameters) comprised of variances and means of predicted bounding box parameters distribution rₙ. These variances and means are computed along the first dimension of rₙ. The term {μₙ}ⱼ₌₁^{J} is the mean bounding box parameters b̅ₙ. Also, let μ_{n,com} denote the combined mean, computed as

$${μ}_{n , c o m} = \frac{1}{J} {\sum }_{j = 1}^{J} {μ}_{n , j} .$$

Then, estimate the (joint) uncertainty μₙ as:

$${u}_{n} = \frac{1}{J} {\sum }_{j = 1}^{J} [ {σ}_{n , j}^{2} + {( {μ}_{n , j} - {μ}_{n , c o m} )}^{2} ] \qquad ( 7 )$$

The certainty gₙ in the n^{th} positive bounding box localization is then computed as: gₙ=1−tanh(uₙ).

These estimated mean logits are leveraged based class-wise confidence, class-wise certainty and the certainty in bounding box localization to formulate the two components of the enhanced auxiliary loss: multi-class confidence calibration (MCC), and localization calibration (LC). The MCC method computes the difference between the fused mean confidence and certainty with the accuracy. The LC calculates the deviation between the predicted mean bounding box overlap (with the ground truth) and the predictive certainty of the bounding box. Both quantities are computed over a mini-batch during training.

In particular, to achieve multi-class confidence calibration (MCC), the mean logits based class-wise confidence and class-wise certainty are leveraged and fused by computing class-wise mean. The resulting vector is termed as the multiclass fusion of mean confidence and certainty. Then, calculate the absolute difference between the fused vector and the accuracy as:

$${ℒ}_{MCC} = \frac{1}{K} {\sum }_{k = 1}^{K} \vert \frac{1}{M} {\sum }_{l = 1}^{{N}_{b}} {\sum }_{n = 1}^{{N}_{p o s}} {v}_{l , n} [ k ] - \frac{1}{M} {\sum }_{l = 1}^{{N}_{b}} {\sum }_{n = 1}^{{N}_{p o s}} {q}_{l , n} [ k ] \vert \qquad ( 8 )$$

where M=N_{b}×Nₚₒₛ. N_{b} is the number of samples in the minibatch and Nₚₒₛ represents the number of positive locations. q_{l,n}[k]=1 if k is the ground truth class of the bounding box predicted for the n^{th} location in the l^{th} sample. v_{l,n}[k]=(s̅_{l,n}[k]+c_{l,n}[k])/2, where s̅_{l,n}[k] and c_{l,n}[k] are the mean confidence and the certainty, respectively, for the class k of the n^{th} positive location in the l^{th} sample. The [symbol] _{MCC} is capable of calibrating the confidence of both the predicted label and non-predicted labels. It penalizes the model if, for a given class k, the fusion (of mean logits based class-wise confidence and certainty in class-wise logits) across a minibatch deviates from the average occurrence of this class across minibatch.

The localization component (LC) is calibrated by leveraging the certainty in bounding box prediction. Next the absolute difference between the mean bounding box overlap (with the ground truth) and the certainty in the bounding box prediction is computed:

$${ℒ}_{L C} = \frac{1}{{N}_{b}} {\sum }_{l = 1}^{{N}_{b}} \frac{1}{{N}_{p o s}^{l}} {\sum }_{n = 1}^{{N}_{p o s}^{l}} \vert [ IoU ( {\overline{b}}_{n , l} , {b}_{n , l}^{*} ) - {g}_{n , l} ] \vert \qquad ( 9 )$$

where Nₚₒₛ^{l} denotes the number of positive bounding box regions in the l^{th} sample. b̅_{n,l} denotes the mean bounding box parameters and g_{n,l} is the certainty for the n^{th} positive bounding box prediction from l^{th} sample.

Both [symbol] _{MCC} and [symbol] _{LC} operate over the mini-batches, and are combined to get an auxiliary loss term [symbol] _{MCCL-aux}.

$${ℒ}_{MCCL - aux} = {ℒ}_{MCC} + β {ℒ}_{L C} \qquad ( 10 )$$

where β is a hyperparameter to control the relative contribution of [symbol] _{LC} to the overall loss [symbol] _{MCCL-aux}.

### EXPERIMENTS

Datasets: The in-domain calibration performance is evaluated using the following five datasets: Sim10K, KITTI, Cityscapes (CS), COCO, and PASCAL VOC (2012). See Matthew Johnson-Roberson, Charles Barto, Rounak Mehta, Sharath Nittur Sridhar, Karl Rosaen, and Ram Vasudevan. Driving in the matrix: Can virtual worlds replace human-generated annotations for real world tasks? In 2017 IEEE International Conference on Robotics and Automation (ICRA), pages 746-753. IEEE, 2017; Andreas Geiger, Philip Lenz, and Raquel Urtasun. Are we ready for autonomous driving? the kitti vision benchmark suite. In Computer Vision and Pattern Recognition (CVPR). 2012 IEEE Conference on, pages 3354-3361. IEEE, 2012; Marius Cordts, Mohamed Omran, Sebastian Ramos, Timo Rehfeld, Markus Enzweiler, Rodrigo Benenson, Uwe Franke, Stefan Roth, and Bernt Schiele. The cityscapes dataset for semantic urban scene understanding. In Proc. of the IEEE Conference on Computer Vision and Pattern Recognition (CVPR), 2016; Tsung-Yi Lin, Michael Maire, Serge J. Belongie, Lubomir D. Bourdev, Ross B. Girshick, James Hays, Pietro Perona, Deva Ramanan, Piotr Doll'a r, and C. Lawrence Zitnick. Microsoft COCO: common objects in context. CoRR, abs/1405.0312, 2014; and M. Everingham, S. M. A. Eslami, L. Van Gool, C. K. I. Williams, J. Winn, and A. Zisserman. The pascal visual object classes challenge: A retrospective. International Journal of Computer Vision, 111(1):98-136, January 2015, each incorporated herein by reference in their entirety.

Several of these datasets include labeled object classes, for use in training machine learning models for object detection. The Cityscapes dataset includes classes for flat surfaces, humans, vehicles, constructions, objects, nature, sky, and void. The KITTI dataset includes classes for cars, pedestrians, and cyclists. The PASCAL VOC dataset includes classes for person, animal, vehicle, and indoor objects. The animal class includes bird, cat, cow, dog, horse, and sheep. The vehicle class includes aeroplane, bicycle, boat, bus, car, motorbike, and train. The indoor object class includes bottle, chair, dining table, potted plant, sofa, and tv/monitor.

Sim10K contains synthetic images of the car category, and offers 10K images which are split into 8K for training, 1K for validation and 1K for testing. See Johnson-Roberson et al. Cityscapes is an urban driving scene dataset and consists of 8 object categoriesIt has 2975 training images and 500 validation images, which are used for evaluation. KITTI is similar to Cityscapes as it contains images of road scenes with a wide view of the area, except that KITTI images were captured with a different camera setup. Car class is used for experiments. Train2017 version of MS-COCO is used and it offers 118K training images, 5K validation images, and 41K test images. See Lin et al. PASCAL VOC 2012 consists of 5,717 training and 5,823 validation images, and provides bounding box annotations for 20 classes. For evaluating out-of-domain calibration performance, use Sim10K to CS, KITTI to CS, CS to Foggy-CS, COCO to Cor-COCO, CS to BDD100K, VOC to Clipart1k, VOC to Watercolor2k, and VOC to Comic2k. See Fisher Yu, Wenqi Xian, Yingying Chen, Fangchen Liu, Mike Liao, Vashisht Madhavan, and Trevor Darrell. Bdd100k: A diverse driving video database with scalable annotation tooling. arXiv preprint arXiv: 1805.04687, 2(5):6, 2018; Naoto Inoue, Ryosuke Furuta, Toshihiko Yamasaki, and Kiyoharu Aizawa. Cross-domain weakly-supervised object detection through progressive domain adaptation. In The IEEE Conference on Computer Vision and Pattern Recognition (CVPR), June 2018, each incorporated herein by reference in their entirety. Foggy Cityscapes (CS-F) dataset is developed using Cityscapes dataset by simulating foggy weather leveraging the depth maps in Cityscapes with three levels of foggy weather. See Christos Sakaridis, Dengxin Dai, and Luc Van Gool. Semantic foggy scene understanding with synthetic data. International Journal of Computer Vision, 126(9):973-992, 2018; incorporated herein by reference in its entirety. Cor-COCO is a corrupted version of MS-COCO val2017 dataset for out-of-domain evaluation, and is constructed by introducing random corruptions with severity levels defined in Hendrycks et al. See Dan Hendrycks and Thomas Dietterich. Benchmarking neural network robustness to common corruptions and perturbations. International Conference on Learning Representations (ICLR), 2019, incorporated herein by reference in its entirety. Clipart1k contains 1K images, which are split into 800 for training and 200 for validation, and shares 20 object categories with PASCAL VOC. See Inoue et al. Both Comic2k and Watercolor2k are comprised of 1K training images and 1K test images, and share 6 categories with Pascal VOC. BDD100k offers 70K training images, 20K test images and 10K validation images. See Fisher Yu, Haofeng Chen, XinWang, Wenqi Xian, Yingying Chen, Fangchen Liu, Vashisht Madhavan, and Trevor Darrell. Bdd100k: A diverse driving dataset for heterogeneous multitask learning. In Proceedings of the IEEE/CVF conference on computer vision and pattern recognition, pages 2636-2645, 2020, incorporated herein by reference in its entirety. The validation set is used for out-of-domain evaluation.

Implementation Details: All experiments are performed using Tesla V100 GPUs. COCO experiments use 8 GPUs and follow training configurations reported in Tian et al. Experiments on all other datasets utilize 4 GPUs and follow training configurations listed in Hsu et al. See Cheng-Chun Hsu, Yi-Hsuan Tsai, Yen-Yu Lin, and Ming-Hsuan Yang. Every pixel matters: Center-aware feature alignment for domain adaptive object detector. In European Conference on Computer Vision, pages 733-748. Springer, 2020, incorporated herein by reference in its entirety. β chosen for Equation (10) is from {0.01, 1}.

Evaluation metrics: The D-ECE metric is defined in Equation (6) at IoU of 0.5 to measure calibration performance. Note that, in addition to classification scores, the metric takes into account the calibration of center-x, center-y, width, and height of the predicted box. Detection performance is reported using mAP and AP @0.5 metrics.

Baselines: The train-time calibration method is compared against models trained with task-specific losses of a CNN-based object detector, namely FCOS, and ViT-based object detector, namely Deformable DETR. See Tian et al. and Zhu et al. The method is then compared with the temperature scaling post-hoc method and further with the recently proposed auxiliary loss functions for classification, including MDCA and AvUC. See Heggalaguppe et al.; and Ranganath Krishnan and Omesh Tickoo. Improving model calibration with accuracy versus uncertainty optimization. Advances in Neural Information Processing Systems, 2020, each incorporated herein by reference in their entirety.

### 1. Results

In-domain experiments: The in-domain performance is compared on five challenging datasets with the models trained with task-specific loss of FCOS in Table 1. The results reveal that the disclosed train-time calibration method (MCCL) consistently improves the calibration performance of the task-specific losses. Notably, when added to the task-specific loss of FCOS, our MCCL reduces the D-ECE by 5.86% and 1.76% in VOC and CS datasets, respectively.

TABLE 1
In-domain calibration performance (in D-ECE %) on five challenging datasets, including Sim10K, KITTI,
Cityscapes (CS), COCO and VOC. Best results are in bold.
In-domain performance

| | Sim10K | | KITTI | | CS | | COCO | | VOC | |
|---|---|---|---|---|---|---|---|---|---|---|
| Methods | D-ECE | AP@0.5 | D-ECE | AP@0.5 | D-ECE | AP@0.5 | D-ECE | AP@0.5 | D-ECE | mAP |
| Baseline (FCOS) | 12.90 | 87.45 | 9.54 | 94.54 | 9.40 | 70.48 | 15.42 | 54.91 | 11.88 | 59.68 |
| Ours (MCCL) | 11.18 | 86.47 | 7.79 | 93.76 | 7.64 | 70.22 | 14.94 | 54.85 | 6.02 | 59.17 |

Out-of-domain experiments: Table 2 and Table 3 report out-of-domain performance on eight challenging shifts. It can be seen that the MCCL method is capable of consistently improving the calibration performance in all shift scenarios. There is a major decrease in D-ECE of 2.91% in Sim10K to CS shift. Similarly, there is a reduction in D-ECE by a visible margin of 2.47% for CS to CS-foggy (CS-F).

TABLE 2
Out-of-domain calibration performance (in D-ECE %) on five challenging domain shifts.
Out-of-domain performance

| | Sim10K → CS | | KITTI → CS | | CS → CS-F | | COCO → Cor-COCO | | CB → BDD100K | |
|---|---|---|---|---|---|---|---|---|---|---|
| Methods | D-ECE | AP@0.5 | D-ECE | AP@0.5 | D-ECE | AP@0.5 | D-ECE | AP@0.5 | D-ECE | AP@0.5 |
| Baseline | 9.51 | 45.18 | 7.53 | 38.11 | 11.18 | 19.81 | 15.90 | 30.01 | 18.82 | 14.18 |
| (FCOS) | | | | | | | | | | |
| Ours (MCCL) | 6.60 | 44.30 | 6.43 | 38.73 | 8.97 | 19.54 | 14.45 | 29.96 | 16.12 | 14.20 |

TABLE 3
Out-of-domain calibration performance on three challenging domain drifts.
Out-of-domain performance

| | VOC → clipart | | VOC → watercolor | | VOC → comic | |
|---|---|---|---|---|---|---|
| Methods | D-ECE | mAP | D-ECE | mAP | D-ECE | mAP |
| Baseline (FCOS) | 1.54 | 14.57 | 3.23 | 24.23 | 3.75 | 9.89 |
| Ours (MCCL) | 1.06 | 13.71 | 2.33 | 28.70 | 2.84 | 11.50 |

Comparison with post-hoc method: Temperature scaling (TS) is chosen as post-hoc calibration for comparison. The temperature parameter T is optimized using a holdout validation set to re-scale the logits of the trained model (FCOS). Table 5 compares the performance of TS with the MCCL method on COCO, Sim10K, CS and COCO corrupted datasets. TS performs inferior to the MCCL method and to the baseline. This could be because when there are multiple dense prediction maps, as in FCOS, it is likely that a single temperature parameter T will not be optimal for the corresponding logit vectors.

Test accuracy/precision: In addition to consistently reducing D-ECE, the MCCL method also preserves the mAP or AP@0.5 in almost all cases. In the in-domain experiments (Table 1), the maximum reduction in AP@0.5 is only 0.98% in the Sim10K dataset. In the out-of-domain experiments (Table 2 & Table 3), it mostly remains same in KITTI to CS, CS to BDD100K, VOC to watercolor, and VOC to comic shifts.

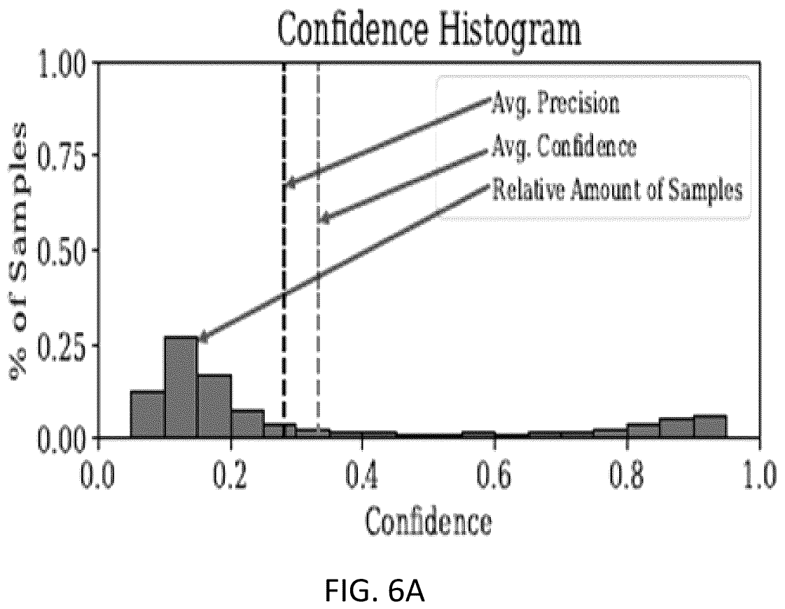

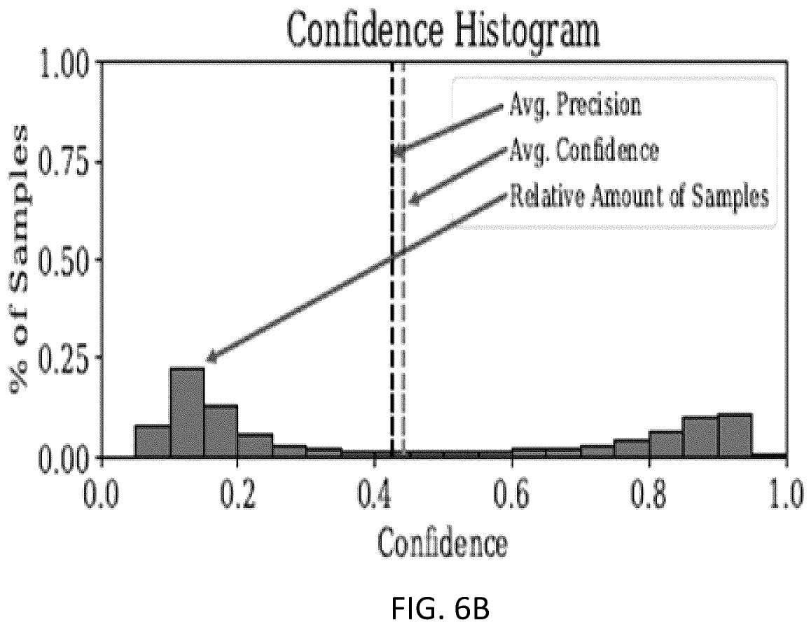

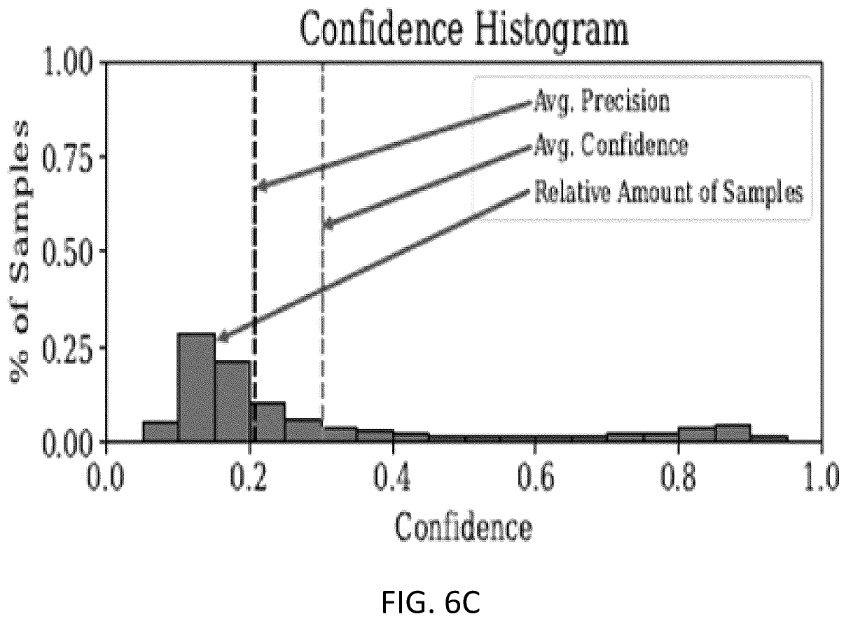

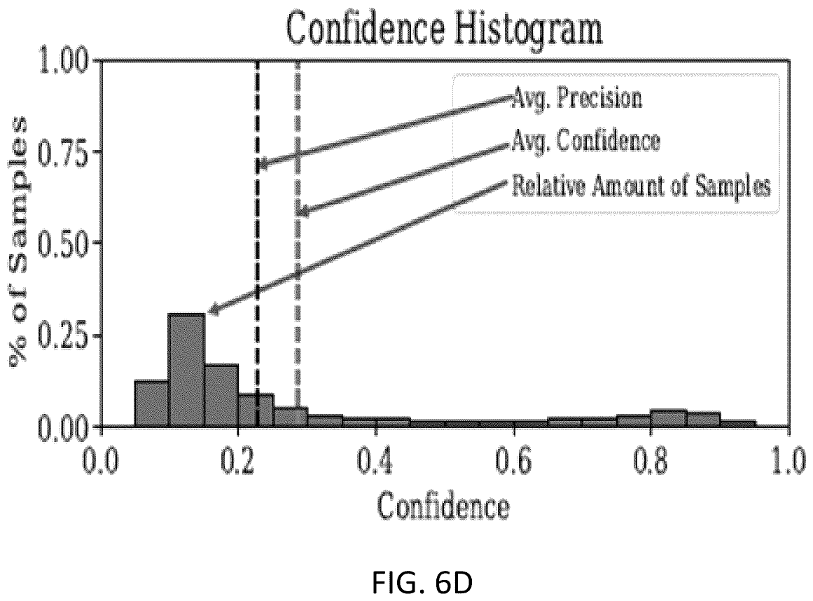

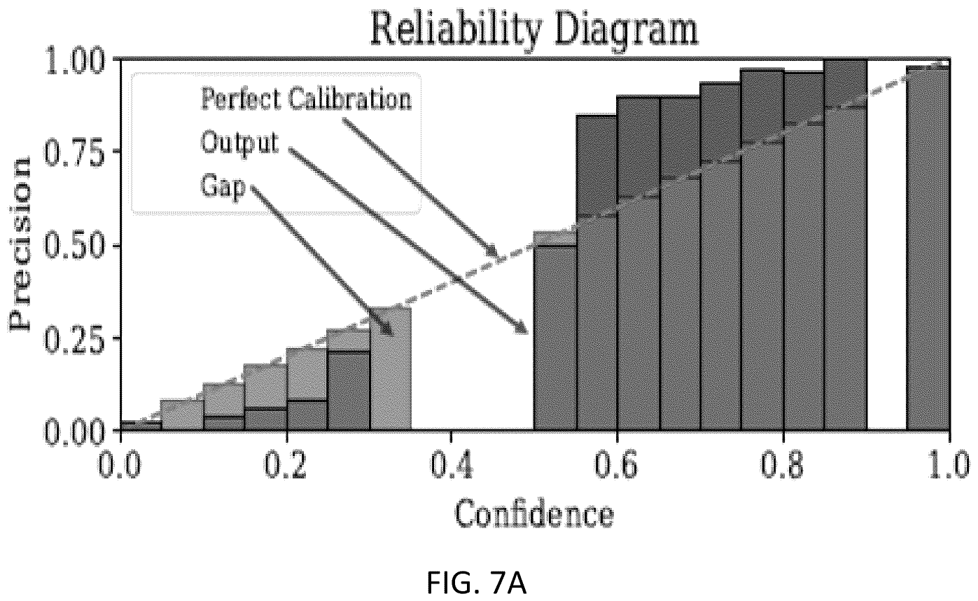

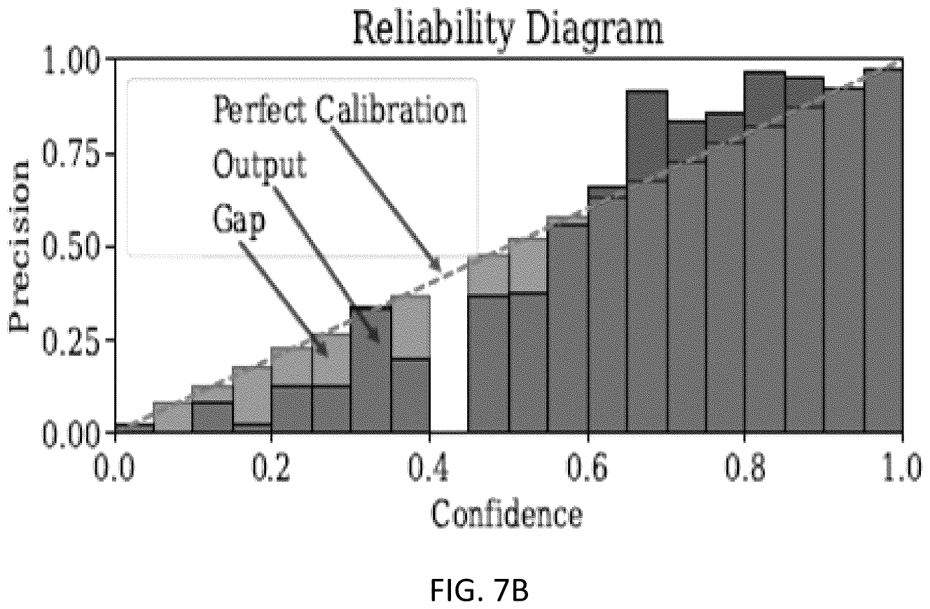

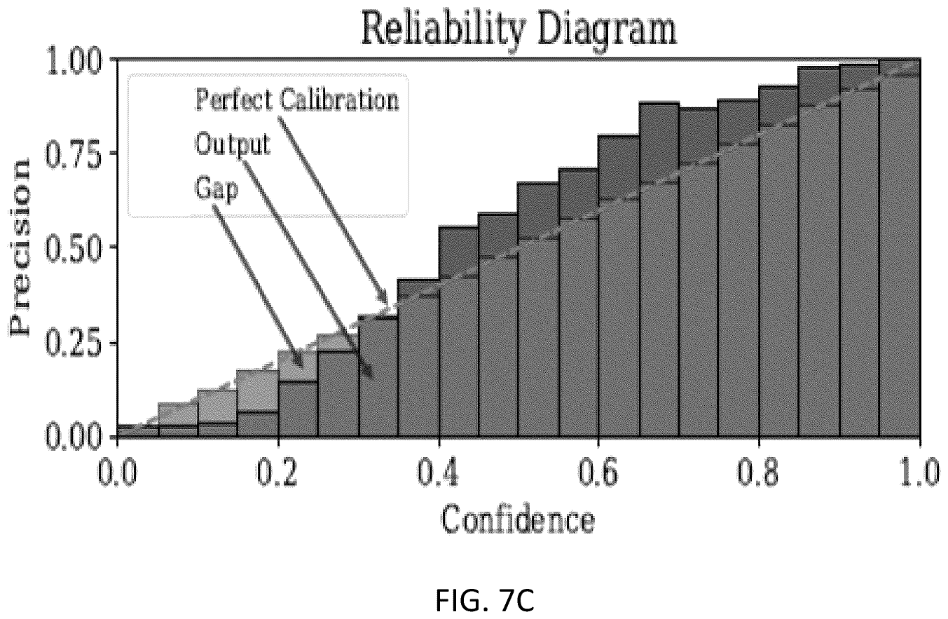

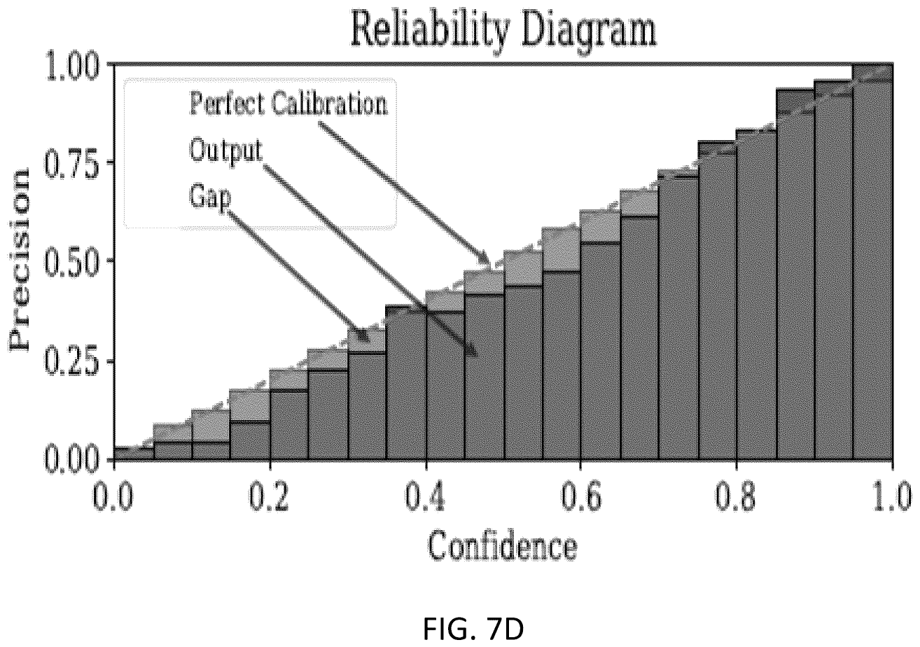

Overcoming under overconfidence: Confidence histogram (FIGS. 6A-6D) are plotted and reliability diagrams (FIGS. 7A-7D) to illustrate the effectiveness of the MCCL method in mitigating overconfidence or underconfidence. In confidence histograms (FIGS. 6A-6D 2) from Sim10K in-domain and CS to CS-F out-of-domain datasets, the average confidence is greater than the average precision which indicates the overconfident model. The MCCL method reduces this gap in both scenarios compared to the baseline (FCOS) method and alleviates the overconfidence of the baseline. Similarly, the reliability diagrams (FIGS. 7A-7D) for VOC in-domain and Sim10K to CS domain shifts reveal that the MCCL method can mitigate both underconfident and overconfident predictions by a visible margin.

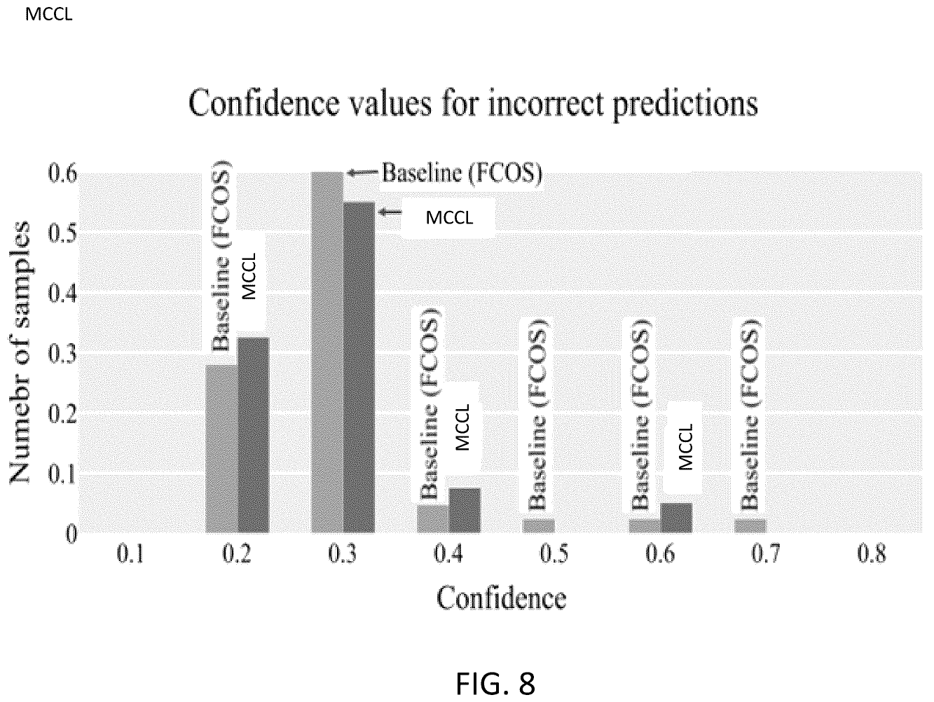

Confidence values of incorrect detections: The confidence of the MCCL method is evaluated in the case of incorrect predictions (FIG. 8). Compared to the baseline, the MCCL method is capable of reducing the confidence of incorrect predictions over the whole spectrum of confidence range.

With another baseline: Table 4 reports results with ViT-based object detector, namely Deformable DETR. See Zhu et al. Compared to FCOS, the Deformable DETR, is already a relatively strong baseline in calibration error. The MCCL method reduces the calibration error (D-ECE) for both in-domain and out-of-domain predictions. The major improvement (2.44% reduction in D-ECE) in calibration performance is observable for KITTI in-domain predictions.

TABLE 4
Comparison of calibration performance of models
trained with ViT-based object detector (Deformable
DeTR) method and after integrating the MCCL method.
Comparison with Deformable DeTR (Baseline)

| | Baseline | | Ours | |
|---|---|---|---|---|
| Dataset | D-ECE | AP@0.5 | D-ECE | AP@0.5 |
| Sim10K | 7.51 | 89.85 | 6.36 | 89.63 |
| KITTI | 6.31 | 96.76 | 3.87 | 96.55 |
| CS | 9.74 | 71.03 | 9.69 | 70.63 |
| COCO | 7.92 | 62.93 | 7.89 | 62.95 |
| VOC | 6.13 | 66.83 | 5.65 | 65.67 |
| Sim10K → CS | 7.28 | 49.65 | 6.79 | 51.55 |
| KITTI → CS | 12.93 | 29.93 | 12.57 | 29.62 |
| CS → CS-F | 9.54 | 25.73 | 9.39 | 25.39 |
| COCO → Cor-COCO | 6.77 | 35.51 | 6.71 | 35.02 |
| VOC → Clipart | 4.32 | 16.40 | 3.55 | 18.11 |
| VOC → Watercolor | 6.60 | 27.23 | 6.56 | 26.51 |
| VOC → Comic | 6.49 | 9.41 | 6.31 | 9.54 |

### 2. Ablation Study

Impact of each component in MCCL: The result of ablation experiments is reported for validating the performance contribution of different components in the MCCL method (Table 5). Moreover, the calibration performance of two train-time calibration losses is reported for image classification: MDCA and AvUC. The following trends are shown in Table 5. The calibration performance of the MCCL method is due to providing not only the class-wise mean logits and mean bounding box parameters to classification loss and regression loss of detection-specific loss, respectively, (MCCL w/o [symbol] _{LC} & [symbol] _{MCC}). Both [symbol] _{MCC} and [symbol] _{LC} are integral components of the MCCL method. They are complementary to each other and their proposed combination is vital to delivering the best calibration performance. For instance, in Sim10K to CS shift, the proposed combination of [symbol] _{MCC} and [symbol] _{LC} achieves a significant reduction in D-ECE compared to MCC and LC alone. Further, the classification-based calibration losses are sub-optimal for calibrating object detection methods.

TABLE 5
Ablations in MCCL and comparison of MCCL with TS, and classification-based train-time losses: MDCA and AvUC.
Ablation study

| | COCO → COCO | | Sim10K → Sim10K | | Sim10K → CS | | COCO → Cor-COCO | |
|---|---|---|---|---|---|---|---|---|
| Methods | D-ECE | AP@0.5 | D-ECE | AP@0.5 | D-ECE | AP@0.5 | D-ECE | AP@0.5 |
| Baseline (FCOS) | 15.42 | 54.91 | 12.90 | 88.01 | 9.51 | 45.18 | 15.90 | 30.01 |
| Post-hoc (TS) | 17.34 | 54.77 | 17.99 | 29.97 | 14.66 | 87.29 | 24.03 | 45.91 |
| AvUC | 15.17 | 54.73 | 13.24 | 87.91 | 10.64 | 39.39 | 15.78 | 29.75 |
| MDCA | 15.25 | 54.44 | 13.99 | 87.95 | 11.14 | 39.51 | 15.33 | 30.07 |
| Ours (w/o [symbol] _{LC} & [symbol] _{MCC}) | 15.26 | 54.25 | 13.12 | 86.34 | 8.87 | 42.89 | 15.28 | 29.67 |
| Ours (w/o [symbol] _{LC}) | 15.00 | 54.11 | 13.00 | 87.86 | 8.63 | 45.31 | 14.52 | 29.73 |
| Ours (w/o [symbol] _{MCC}) | 15.12 | 54.40 | 12.86 | 87.24 | 9.12 | 41.14 | 15.54 | 29.61 |
| Ours (MCCL) | 14.94 | 54.85 | 11.18 | 86.47 | 6.60 | 44.29 | 14.45 | 29.96 |

### See Hebbalaguppe et al. and Krishnan et al.

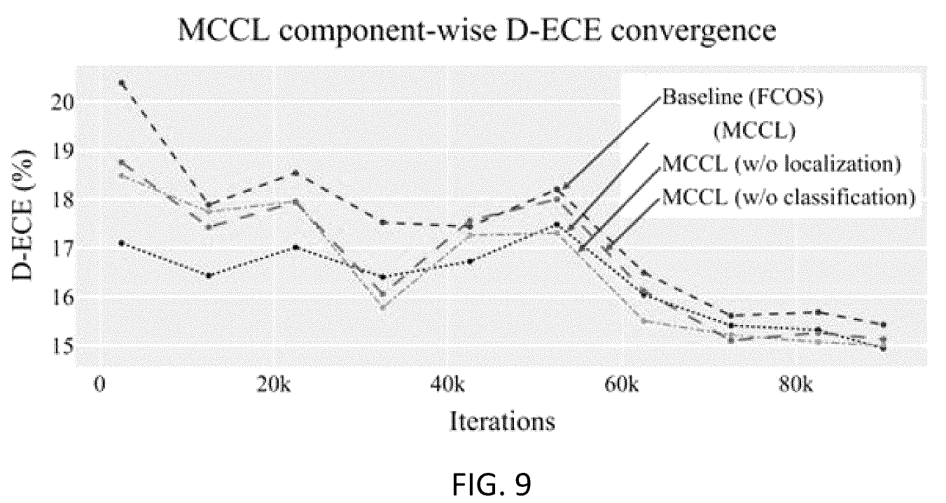

D-ECE convergence: FIG. 9 compares the convergence of D-ECE for baseline, the two components (classification and localization) of our method (MCCL), and MCCL. Although our MCCL and its two constituents does not directly optimize the D-ECE metric, they provide improved D-ECE convergence compared to the baseline.

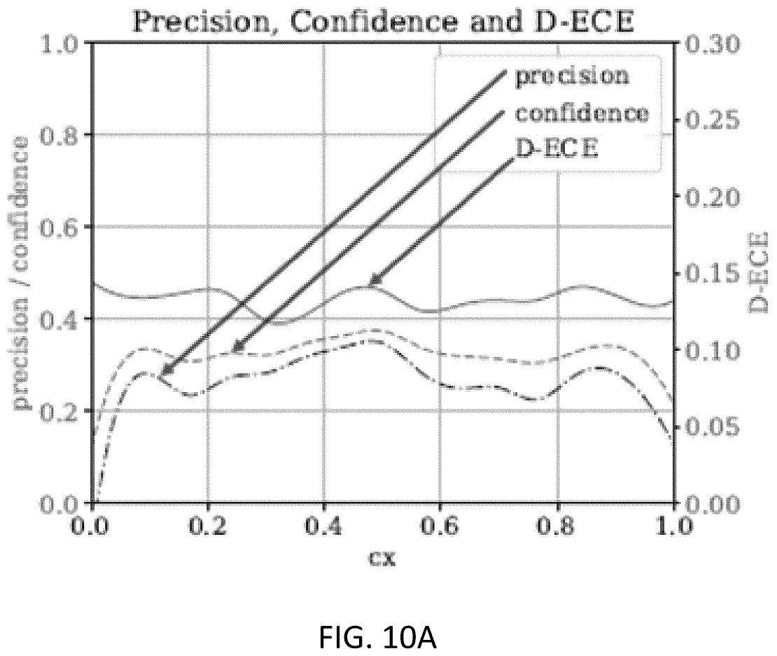

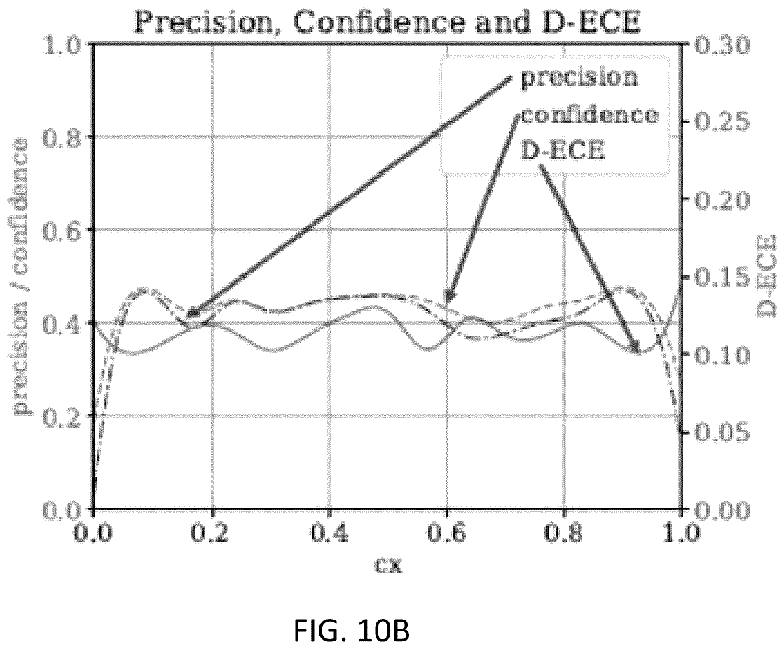

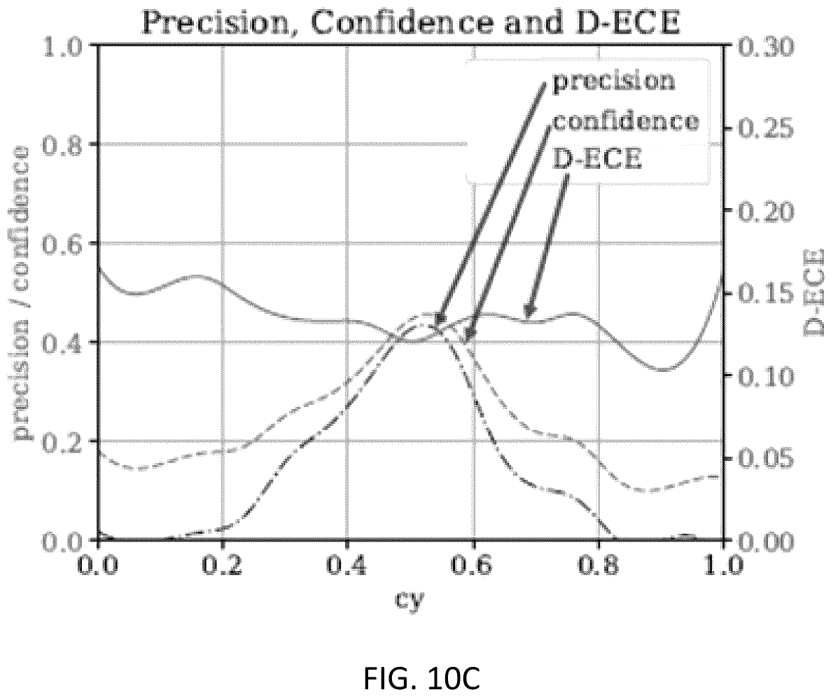

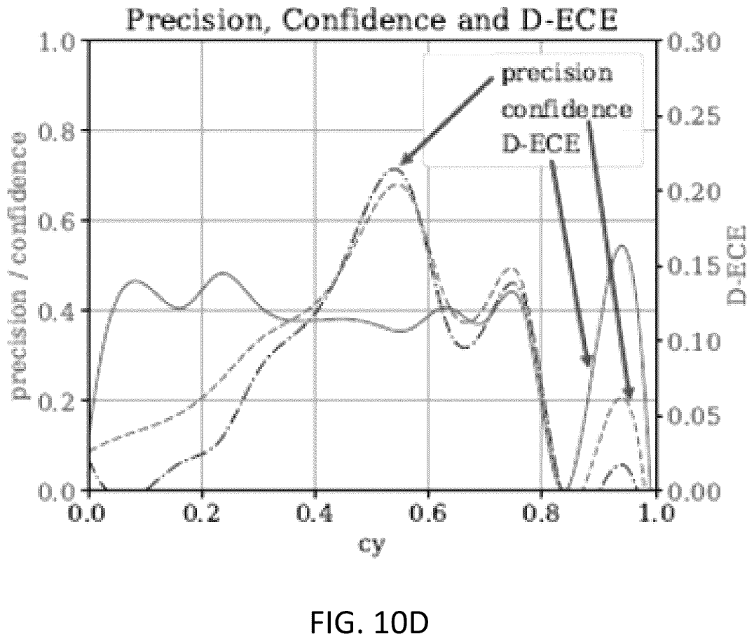

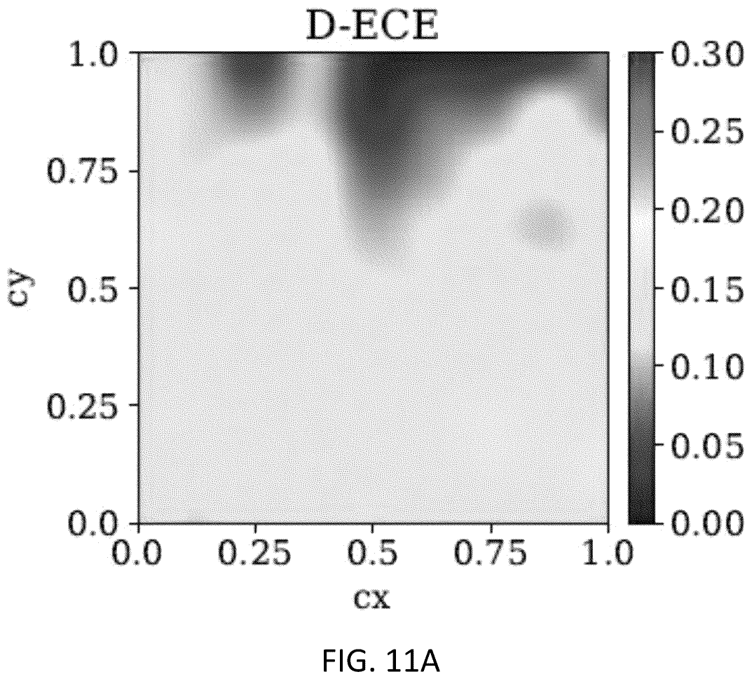

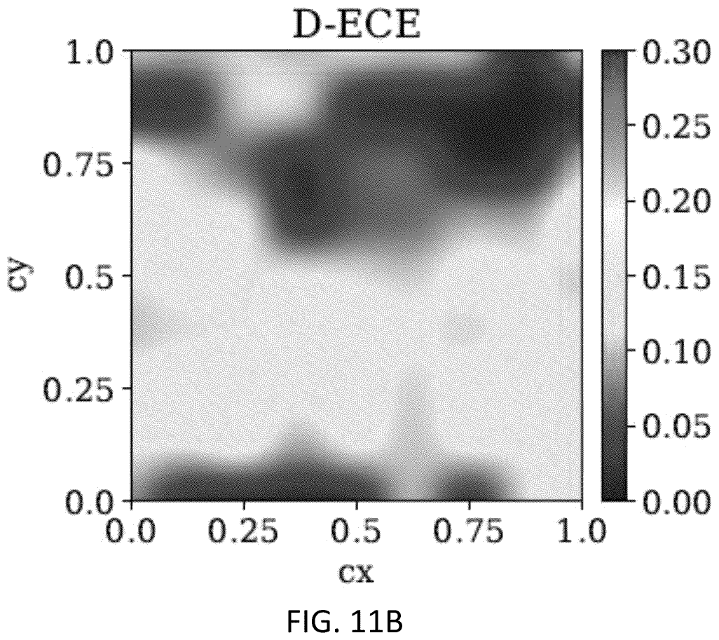

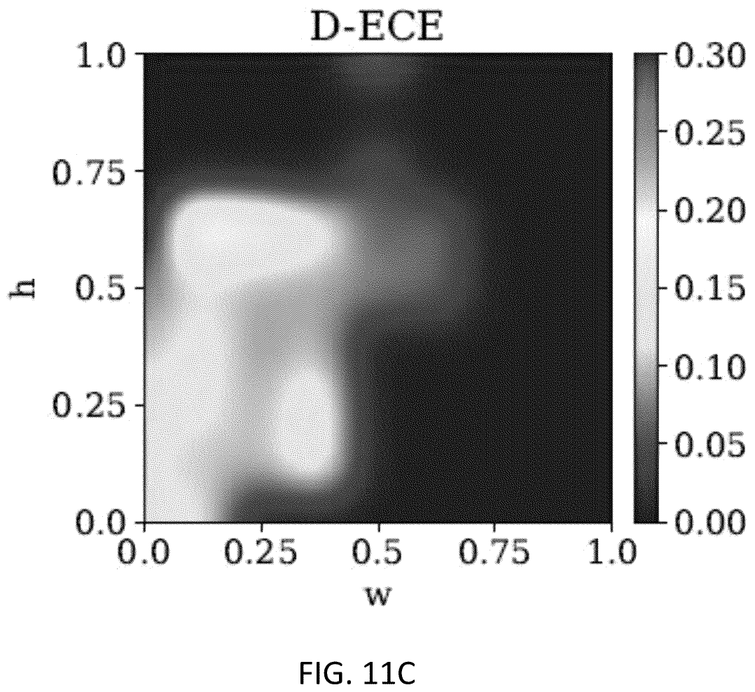

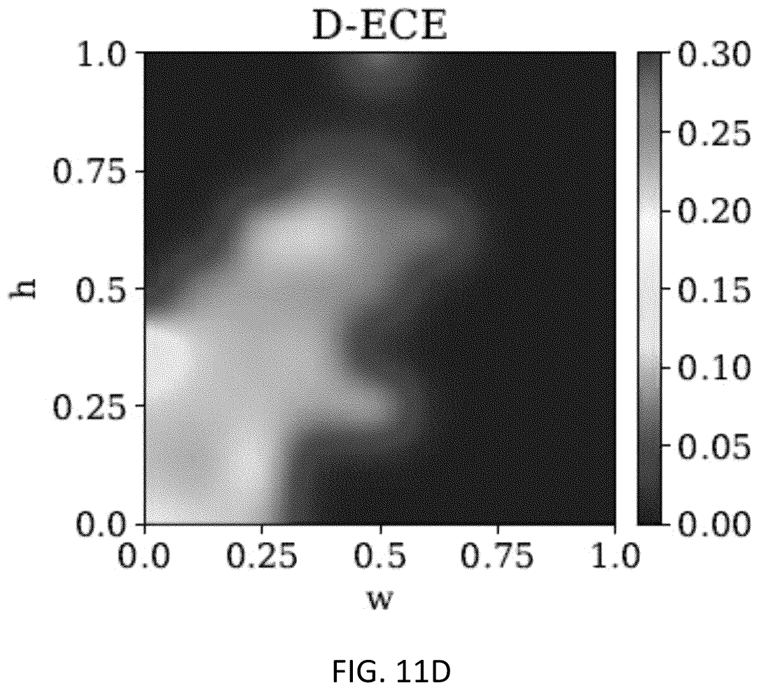

Impact on location-dependent calibration: FIGS. 10A-10D and FIGS. 11A-11D depict that miscalibration error (D-ECE) relies highly on the relative object location (cₓ, c_{y}) and/or its relative width and height (w, h). Moreover, an approach tends to increase as image boundaries. FIG. 6 plots the precision, confidence and D-ECE over individual parameters i.e. cₓ. FIGS. 11A-11D plots 2D calibration heatmaps over object location and width/height, where each location in a heatmap represents D-ECE. Both figures show that, compared to the baseline, besides other locations, the MCCL method can decrease D-ECE at image boundaries. FIGS. 10A-10D also shows that, compared to baseline, the MCCL method allows the adaptation of confidence score at all image locations differently by adjusting the shape of confidence curve accordingly.

MCDO overhead & its Tradeoff analysis: Table 6 reveals that, in the MCCL implementation, upon increasing Monte-Carlo dropout (MCDO) passes N={3, 5, 10, 15},there is a little overhead in time cost over N=1. Table 7 shows the impact of varying the number of MC dropout passes (N) on calibration performance. Upon increasing the N, there is improved calibration, especially in OOD scenario.

TABLE 6
Increment in time per iteration (in secs) over
N = 1 upon increasing MC forward passes.
Time cost with MC dropout

| N | N = 1 | N = 3 | N = 5 | N = 10 | N = 15 |
|---|---|---|---|---|---|
| Time per iteration(s) | 0.143 | 0.197 | 0.243 | 0.350 | 0.463 |
| Increment | — | 0.372 | 0.694 | 1.442 | 2.230 |

TABLE 7
Impact on D-ECE after increasing N in MC dropout.
Calibration performance with MC dropout

| Method | Metric | Baseline | N = 3 | N = 5 | N = 10 | N = 15 |
|---|---|---|---|---|---|---|
| COCO | D-ECE | 16.57 | 16.27 | 16.25 | 16.19 | 16.12 |
| | AP@0.5 | 52.34 | 51.00 | 51.49 | 51.23 | 51.89 |
| COCO- | D-ECE | 17.27 | 16.18 | 16.21 | 15.87 | 16.17 |
| Corr. | AP@0.5 | 29.25 | 28.24 | 28.59 | 28.31 | 28.20 |

The present disclosure provides a method and system that exploit a train-time technique for calibrating DNN-based object detection methods. One aspect of the method/system is an auxiliary loss which targets jointly calibrating multiclass confidence and box localization after leveraging respective predictive uncertainties. The method and system of the present disclosure can consistently reduce the calibration error of object detectors from two different DNN-based object detection paradigms for both in-domain and out-of-domain detections.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A method of training a deep neural network (DNN) for multi-class object detection using an object detection system, the object detection system including a camera and a controller having the DNN, the method comprising:
capturing an image by the camera;
receiving, by the controller, the image;
predicting, using the DNN, at least one bounding box and a class label with a confidence score for the image;
calibrating the DNN by
a multi-class confidence calibration, and
a bounding box localization calibration; and
outputting, by the controller, a calibrated image with the object bounding box, the corresponding class label, and a respective confidence score, wherein the confidence score is a probability associated with the predicted class label.

2. The method of claim 1, further comprising
determining the multi-class confidence calibration by determining a difference between a fused mean confidence and a certainty with accuracy, wherein the fused mean confidence is between a mean logits-based class-wise confidence and class wise certainty.

3. The method of claim 1, further comprising determining the localization calibration by determining a deviation between a predicted mean bounding box overlap and a predictive certainty of the bounding box.

4. The method of claim 1, further comprising determining the multi-class confidence calibration by calibrating the confidence of a predicted label and a non-predicted label.

5. The method of claim 1, further comprising perceiving, by the DNN, multiple object classes in the received image.

6. The method of claim 5, further comprising outputting, by the controller, a control action based on the calibrated image with the object bounding box and the corresponding label.

7. A vehicle safety-critical control system, comprising:
a camera capturing an image;
a controller receiving the image and configured with a deep neural network;
the DNN configured to predict at least one bounding box and a class label with a confidence score for the image;
the controller further configured to calibrate the prediction by the DNN by
a multi-class confidence calibration, and
a bounding box localization calibration; and
the controller further configured to output a calibrated image with the object bounding box, the corresponding class label, and a respective confidence score, wherein the confidence score is a probability associated with the predicted class label.

8. The system of claim 7, further comprising
the controller determining the multi-class confidence calibration by determining a difference between a fused mean confidence and a certainty with accuracy, wherein the fused mean confidence is between a mean logits-based class-wise confidence and class wise certainty.

9. A system of claim 7, further comprising the controller determining the localization calibration by determining a deviation between a predicted mean bounding box overlap and a predictive certainty of the bounding box.

10. The system of claim 7, further comprising the controller determining the multi-class confidence calibration by calibrating the confidence of a predicted label and a non-predicted label.

11. The system of claim 7, further comprising the DNN perceiving multiple object classes in the received image.

12. The system of claim 11, further comprising the controller outputting a control action based on the calibrated image with the object bounding box and the corresponding label.

13. The system of claim 7, further comprising
a braking system,
wherein the controller is further configured to actuate the braking system based on an object predicted by the controller.

14. The system of claim 7, further comprising a steering system, the controller further configured to actuate the steering system in conjunction with the braking system based on an object predicted by the controller.

15. The system of claim 7, further comprising a transmission system, the controller further configured to actuate the transmission system, the steering system, and the braking system based on an object predicted by the controller.

16. A non-transitory computer-readable storage medium including computer executable instructions, wherein the instructions, when executed by a computer, cause the computer to perform a method comprising:
receiving an image;
predicting, using a deep neural network (DNN), at least one bounding box and a class label with a confidence score for the image;
calibrating the DNN by
a multi-class confidence calibration, and
a bounding box localization calibration; and
outputting a calibrated image with the object bounding box, the corresponding class label, and a respective confidence score, wherein the confidence score is a probability associated with the predicted class label.

17. The computer-readable storage medium of claim 16, further comprising
determining the multi-class confidence calibration by determining a difference between a fused mean confidence and a certainty with accuracy, wherein the fused mean confidence is between a mean logits-based class-wise confidence and class wise certainty.

18. The computer-readable storage medium of claim 16, further comprising
determining the localization calibration by determining a deviation between a predicted bounding box overlap and a predictive certainty of the bounding box.

19. The computer-readable storage medium of claim 16, further comprising
determining the multi-class confidence calibration by calibrating the confidence of a predicted label and a non-predicted label.

20. The computer-readable storage medium of claim 16, further comprising
perceiving, by the DNN, multiple object classes in the received image.
